(19) United States
(12) Patent Application Publication
(10) Pub. No.: US 2007/0289024 A1
(43) Pub. Date: Dec. 13, 2007

(54) Controlling access to computer resources using conditions specified for user accounts

(75) Inventor: Yunus Mohammed, Bellevue, WA (US)

Correspondence Address: MICROSOFT CORPORATION, ONE MICROSOFT WAY, REDMOND, WA, 98052-6399, US

(73) Assignee: Microsoft Corporation Microsoft Patent Group, Redmond, WA (US)

(21) Appl. No.: 11/450,527

(22) Filed: Jun. 9, 2006

(51) Int. Cl. H04L 9/32

(52) U.S. Cl. 726/28

(57) ABSTRACT

Permission to access a particular computer resource is controlled by establishing conditions for each user account that may be used for log-in to the computer system providing the computer resource. The user account may represent a single user, a group of individual users, or large groupings of individual users such as network domains. The computer resource may include files, local or on-line services, and the like. Once the conditions are set for the user account and the given resource, then upon attempts by a user who is logged in via the user account to access the resource, the one or more conditions are checked to determine whether access should be granted.

### BACKGROUND

Computer resources such as individual files, registry keys, network file shares, local and on-line services, and so forth are accessed from a user account that has been used to log-in to a computer system or network. User accounts include individual accounts, such as Active Directory accounts, emails accounts and so forth. As used herein, user accounts may also include groupings of individual such as domains.

Not all user accounts, either at the individual or group level, should have access to all computer resources that may be available upon logging-in to a computer system or network. Thus, user account permissions are established for the available computer resources such that a user account either has the permission to access a particular resource or does not. Often, a user account should have access to a particular resource but only for a limited time. Administrators must keep track of user accounts that have permission to access a particular resource and must then manually revoke the permission to access at the appropriate time. This is burdensome for administrators and is subject to human error that may introduce security risks or other negative consequences.

### SUMMARY

Embodiments address these issues and others by allowing one or more conditions to be specified for a particular user account and a particular computer resource so that those conditions can be checked before permitting the user account to have access to the resource. For example, an administrator may be provided a user interface upon which to select conditions for a given computer resource and user account. When a user account attempts to access the computer resource for which the one or more conditions have been specified, the one or more conditions are found and implemented by a computer system. Access is provided to the user only upon the computer system determining that the one or more conditions are satisfied. Thus, access to computer resources may be controlled without requiring an administrator to keep track of whether a particular user account should have access and to manually set a permission for a given resource as access granted or access denied.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an example of one or more computer systems for implementing embodiments.

FIG. 2 shows an example of an operational flow of a conditional permission setting routine.

FIG. 3 shows an example of a user interface provided by the conditional setting routine.

FIG. 4 shows an example of an operational flow for receiving and storing data specifying the conditions through the user interface of FIG. 3.

FIG. 5 shows an example of an operational flow for granting or denying a user account access to a resource.

FIG. 6 shows an example of an operational flow for checking conditional permissions prior to granting or denying a user account access to a computer resource.

### DETAILED DESCRIPTION

Embodiments provide conditional permissions for user accounts such that access to a given computer resource can be controlled on a user account by user account basis. As the outcomes of the conditions change, the access rights to computer resources may change as well. As the conditional permissions are implemented by a computer controlling access to the computer resources, the administrator is freed from manually switching permissions to a resource on and off for user accounts.

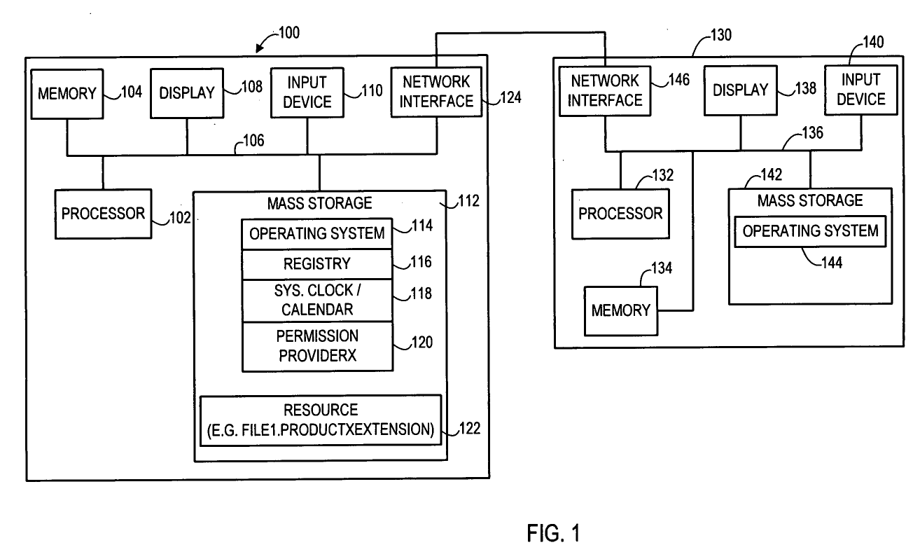

FIG. 1 shows an example of a computer system 100 that provides an operating environment for the embodiments. The computer system 100 as shown may be a standard, general-purpose programmable computer system 100 including a processor 102 as well as various components including mass storage 112, memory 104, a display adapter 108, and one or more input devices 110. The processor 102 communicates with each of the components through a data signaling bus 106. The computer system 100 may also include a network interface 124, such as a wired or wireless connection, that allows the computer system 100 to communicate with other computer systems such as computer system 130. The computer system 100 may alternatively be a hard-wired, application specific device that implements one or more of the embodiments.

In the example, of FIG. 1, the processor 102 implements instructions stored in the mass storage 112 in the form of an operating system 114. The operating system 114 of this example maintains a registry 116 which provides configuration information for operation of the computer system 100. The operating system 114 also maintains system clock and calendar data 118, which may be obtained from a non-volatile memory source that maintains such information.

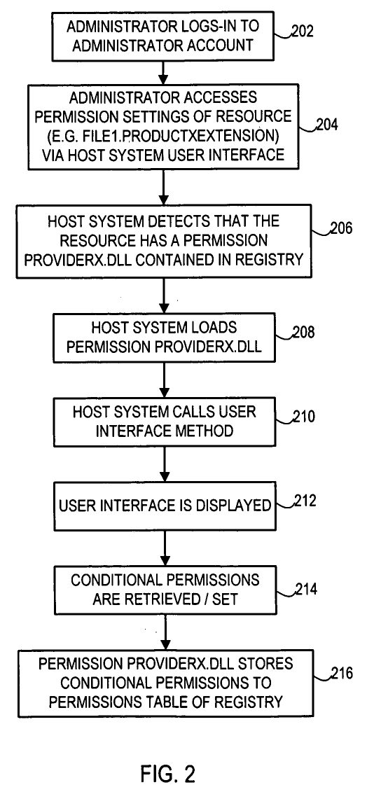

Additionally, these embodiments provide logic for implementation by the processor 102 in order to assign conditional permissions to computer resources and then analyze those conditional permissions upon attempts by user accounts to access the computer resources. In the example, shown in FIG. 1, the logic is in the form of a library such as a dynamically linked library (DLL) which contains various methods that the operating system may call upon to perform the logic and thereby implement the conditional permissions. It will be appreciated that the logic may be implemented in other manners, depending upon the particular operating system 114 being implemented. Examples of the logic to be performed are discussed below in relation to FIGS. 2-6. In this example, the logic is referred to as a permission provider, and specifically PermissionProviderX.dll.

The example of FIG. 1 also shows a computer resource 122 to be accessed. The computer resource 122 may be of various types. The computer resource may be a single file, a registry key of registry 116, a network file share, a local or on-line service, and the like. In the example shown, the resource is a file named FILE1.PRODUCTXEXTENSION, where this file is one file of an application referred to as Product X.

In some embodiments, the computer system 100 acts as a host system where client systems access the computer resources being controlled by the host system, such as the network file share and/or the on-line services such as Internet services. In the example shown, the computer system 130 is a client system where the user of the computer system 130 wishes to access a computer resource under the control of host system 100. Furthermore, a client computer 130 may be used by an administrator to configure the conditional permissions for the resources of the host system 100. The computer system 130 of this example includes similar components to those of computer system 100, such as a processor 132, memory 134, data bus 136, display 138, input device 140, mass storage 142, operating system 144, and network interface 146.

The computer system 100 of FIG. 1, as well as the client computer system 130, typically includes a variety of computer readable media. Such computer readable media contains the instructions for operation of the computer system and for implementation of the embodiments discussed herein. Computer readable media can be any available media that can be accessed by computer 100 and includes both volatile and nonvolatile media, removable and non-removable media. By way of example, and not limitation, computer readable media may comprise computer storage media and communication media.

Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer system 100.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

FIG. 2 shows one example of the logical operations performed by an embodiment for establishing the conditional permissions for a computer resource. Initially, in this example the administrator logs-in to the host computer system 100 using an administrator or user account that has permission setting privileges at log-in operation 202. The administrator then accesses the permission settings of the computer resource of interest, FILE1.PRODUCTXEXTENSION of this example, at access operation 204. The administrator may access the permission settings in a conventional manner via the host system user interface, such as by finding the resource listed in a directory and performing a right-click to bring up a list of options that includes the permission option, or a properties option that exposes the permissions.

Upon the administrator having attempted access to the permissions settings for the resource of interest, the host system scans the registry 116 and determines that the registry contains an association of this resource to PermissionProviderX.dll at registry operation 206. Each permission provider of this example is registered with the host system in the Registry 116 or in any other system configuration location. For example, the Registry 116 may specify:

| | |
|---|---|
| Key: | Value: |

My Computer\HKEY_CLASSES_ROOT\.productxextension\

| | |
|---|---|
| PermissionProvider | C:\ProgramFiles\ProductX\PermissionProviderX.dll |

My Computer\HKEY_CLASSES_ROOT\.productyextension\

| | |
|---|---|
| PermissionProvider | C:\ProgramFiles\ProductY\PermissionProviderY.dll |

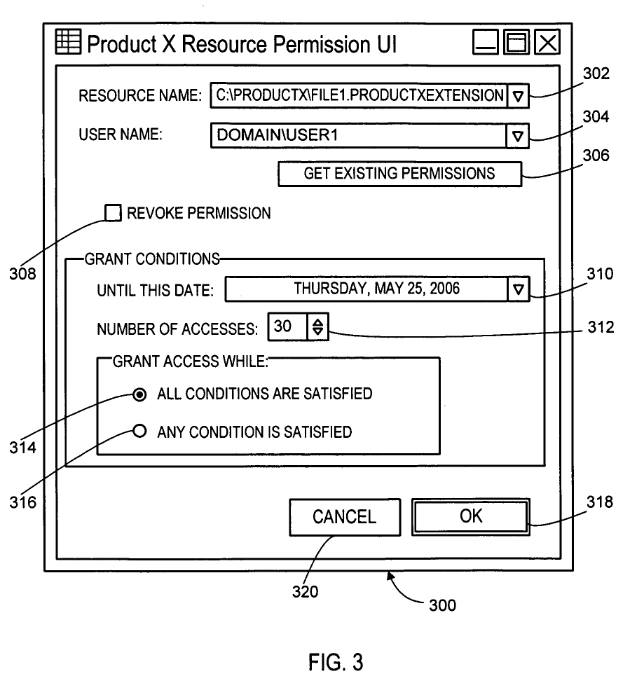

Each of the permission providers utilized by the host system may have their own unique set of conditions for granting or denying access. For example, PermissionProviderX may have the conditions discussed below in relation to FIG. 3 while PermissionProviderY may have its own unique set of conditions for granting or denying access. The provider may offer the permission provider with conditions that are tailored to the particular product. For example, the conditions for access to an on-line game may be entirely different than the conditions for access to a medical records database.

Upon the host system 100 finding the association in the Registry 116, the host system then loads the associated permission provider, PermissionProviderX.dll in this example, from storage at load operation 208. The host system 100 then calls a user interface method of that permission provider at call operation 210. As a result, the user interface is displayed on the display screen for viewing by the administrator at display operation 212.

An example of a user interface of such a permission provider is shown in FIG. 3. This screen capture of the user interface 300 for PermissionProviderX includes a field 302 for displaying the resource currently being assigned conditional permissions. This field 302 is automatically populated based upon the particular resource for which the administrator has attempted to access the permission settings. However, in certain embodiments, field 302 may also allow the administrator to select different resources, such as by manually entering the resource path or by field 302 acting as a drop down menu to provide the administrator with a list of resource options to select. For example, as shown the administrator is currently setting permissions for file1 for Product X but the drop down may allow the administrator to select file 2, file 3, and so on for Product X or even select a resource for Product Y.

As the permissions being assigned to the resource are on a user account basis, field 304 acts as an entry point for the user account name. The field 304 may accept manual entry of the user account name or may act as a drop down menu to provide the administrator with a list of user account name options to select. As discussed above, a user account may refer to a single user or to a group of users such as an entire domain or Active Directory. In the example shown, permissions are being assigned to the individual USER1 of DOMAIN.

The administrator can select control button 306 in order to obtain the existing permissions, if any, for the current resource and user account. Upon selecting this option, the remaining fields of the user interface 300 are populated with data specifying the existing conditional permissions, if any do exist. The user interface method obtains the permissions from a permission table maintained in the Registry 116 or elsewhere. This permissions table is discussed in more detail below, particularly with reference to Table 1.

The administrator has several options available in the user interface 300. These options are provided for purposes of illustration. It will be appreciated that the options available for establishing conditional permissions may vary from one implementation to the next. Furthermore, the options available may be customizable by the administrator for a given product or resource to be configured or for a given host computer 100.

A first option is checkbox 308 for selecting to revoke permission to access the specified resource via the specified user account. Thus, if checkbox 308 is selected, then USER1 of DOMAIN will no longer have access to FILEl.PRODUCTXEXTENSION. The remaining options are grant conditions, or conditions that need to be satisfied in order to grant access to the specified resource for the specified user account.

A first grant condition is a grant until date that may be selected via field 310. Field 310 may accept a manual entry of a date or may provide a drop down such as a calendar from which a selection can be made. This grant until date indicates that the specified user can no longer access the specified resource once this date arrives.

A second grant condition is a number of accesses that may be selected via field 312. Field 312 may accept manual entry of a number and/or may provide up/down buttons to increase or decrease a displayed number. The number of accesses indicates that the specified user can no longer access the specified resource after having already accessed the resource by this number of accesses.

A third grant condition is whether the grant conditions must all be satisfied to grant access, or whether only a single grant condition must be satisfied even though multiple ones are set. Bullet 314 specifies that all must be satisfied while bullet 316 specifies that only any single one must be satisfied. For this example, if all must be satisfied, then both the grant until date and the number of accesses conditions must be met to grant access. If any must be satisfied, then so long as either the grant until date condition or the number of accesses condition is met, then access is granted.

The user interface 300 of this example also includes an OK button 318 and a cancel button 320. Thus, an administrator may make settings and click button 318 to accept and implement then or click button 320 to cancel them and return to existing permissions.

As noted above, the options to the administrator may vary from those of the example shown in FIG. 3 and discussed in further detail below. For example, there could be a revoke until date specified as a condition. There could be grant conditions including: grant for N number of days after the user account is first created, grant until M number of login sessions have occurred, and/or grant until H number of logged in hours have passed.

Returning to FIG. 2, the conditional permissions are retrieved and/or set at permissions operation 214 via a user interface such as that of FIG. 3 or by other manner of manual data input, such as direct entry to a table. The permission provider then stores the conditional permissions that have been set to a permissions table, such as in the Registry 116 or other similar system configuration location at store operation 216. For example, the Registry 116 may specify:

My Computer\HKEY_LOCAL_MACHINE\SOFTWARE\
SoftwareVendorSX\ProductX

| Key: | Value: |
|---|---|
| PermissionsTable | <BinaryValue> |

An example of a format of the Permissions Table is shown in Table 1.

TABLE 1

| | User | |
|---|---|---|
| Resource | Account | Conditional Permissions |
| C:\ProductX\File1.ext | Domain/ | <Conditions Type=”Grant” |
| | User1 | Satisfy=”All”><Condition |
| | | Name=”ExpiryDate”>05/25/2006 |
| | | </Condition><Condition |
| | | Name=”MaxAccessCount”>30 |
| | | </Condition></Conditions> |
| C:\ProductX\File2.ext | Domain/ | <Conditions Type=”Revoke”> |
| | User1 | </Conditions> |
| C:\ProductX\File1.ext | Domain/ | <Conditions Type=”Grant” |
| | User2 | Satisfy=”Any”><Condition |
| | | Name=”ExpiryDate”>05/25/2006 |
| | | </Condition><Condition |
| | | Name=”MaxAccessCount”>30 |
| | | </Condition></Conditions> |

As can be seen in Table 1, each resource has its own conditional permissions per user. Table 1 specifies conditional permissions for User1 of Domain for File 1 of Product X, including those conditions shown in the user interface 300 of FIG. 3. Table 1 specifies that User1 of Domain has permissions revoked for File 2 of Product X. Table 1 also specifies conditional permissions for User2 of Domain for File 1 of Product X. The conditional permissions for User2 differ from those set for User1 in that any satisfied condition will allow access for User2 while all conditions must be satisfied to allow access for User1.

In one illustrative embodiment, the Permissions Table may take the form of an Access Control List (ACL) or similar structure containing Access Control Elements (ACE), where the Table specifies an access mask to grant certain permissions for a resource. The ACL has an additional field, namely, the conditional permissions field, so that the access specified by the access mask is effective only upon the conditions to the permissions being satisfied as described herein.

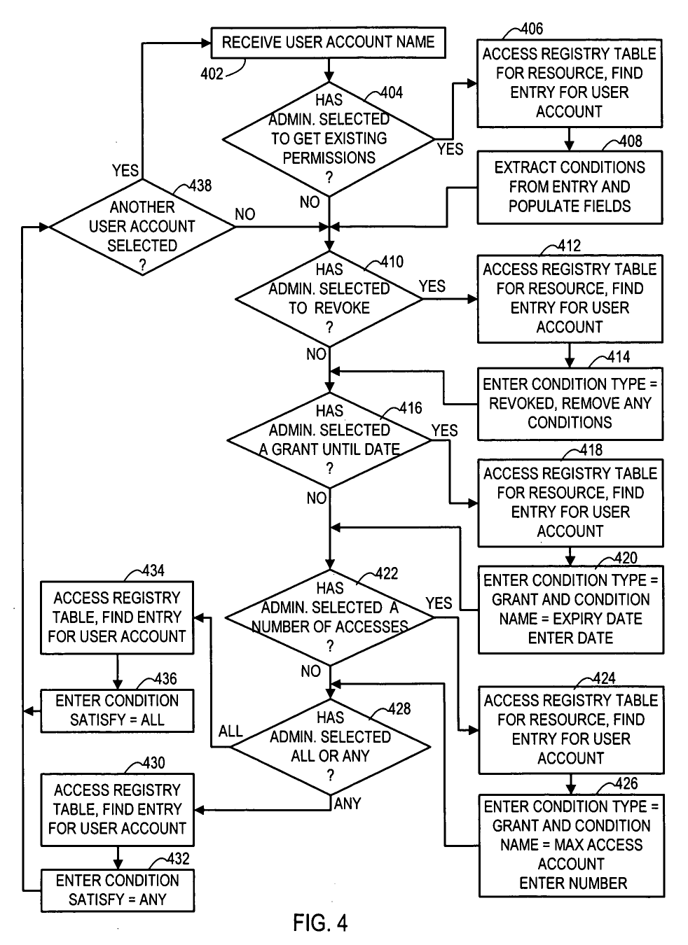

FIG. 4 shows a more detailed set of logical operations for interaction between the user interface 300 of FIG. 3 and the administrator for purposes of setting the conditional permissions as shown in Table 1. The operations begin by receiving the user account name at name operation 402. Then, at query operation 404, it is detected whether the administrator has selected to get existing permissions. If so, then the registry table is accessed at table operation 406 to find the entry for the user account and current resource. The conditions and other data are then extracted from the table and the fields of the user interface are populated at extraction operation 408. Operational flow then proceeds to query operation 410.

If the administrator has not yet selected to get the existing permissions, then operational flow proceeds directly to query operation 410 where it is detected whether the administrator has selected to revoke permission to access the current resource. If so, then the registry table is accessed at table operation 412 to find the entry of the user account and current resource. The condition type is then entered as “revoked” and all other conditions are removed at entry operation 414, and operational flow then proceeds to query operation 416.

If the administrator has not yet selected to revoke permission, then operational flow proceeds directly to query operation 416 where it is detected whether the administrator has selected a grant until date. If so, then the registry table is accessed at table operation 418 to find the entry of the user account and current resource. The condition type is then entered as “grant” and a condition name is entered as “expiry date” with the date set to what the administrator has chosen at entry operation 420. Operational flow then proceeds to query operation 422.

If the administrator has not yet selected a grant until date, then operational flow proceeds directly to query operation 422 where it is detected whether the administrator has selected a number of accesses. If so, then the registry table is accessed at table operation 424 to find the entry of the user account and current resource. The condition type is then entered as “grant” and a condition name is entered as “max access account” with the number set to what the administrator has chosen at entry operation 426. Operational flow then proceeds to query operation 428.

If the administrator has not yet selected a number of accesses, then operational flow proceeds directly to query operation 428 where it is detected whether the administrator has selected for all conditions to be satisfied or any conditions to be satisfied before access is granted. If the administrator has selected “any,” then the registry table is accessed at table operation 430 to find the entry of the user account and current resource. The condition satisfy element is then set to “any” at entry operation 432, and operational flow proceeds to query operation 438. If the administrator has selected “all,” then the registry table is accessed at table operation 434 to find the entry of the user account and current resource. The condition satisfy element is then set to “all” at entry operation 436, and operational flow proceeds to query operation 438.

At query operation 438, it is detected whether the administrator has selected another user account for the current resource. If so, then operational flow returns to name operation 402 where the use account name is obtained from the data field. If not, then operational flow returns to query operation 410 to then proceed through the series of queries regarding user input in the user interface.

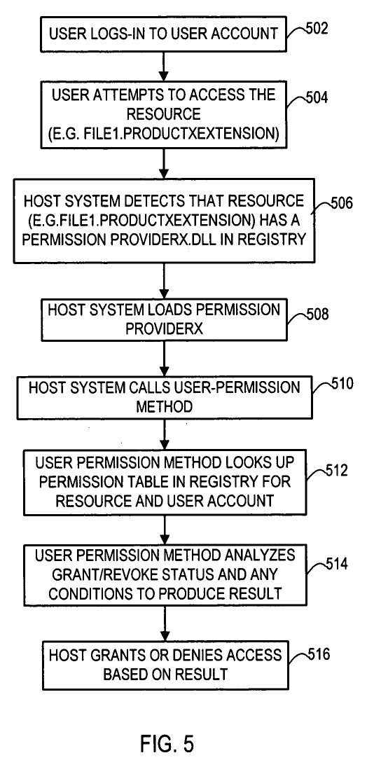

FIG. 5 shows an example of logical operations performed by the host computer system 100 to apply the conditional permissions upon a user account attempting to access a resource. The operations begin by the user logging in to the host computer 100 via a user account at log-in operation 502, such as by directly accessing the host computer 100 or by utilizing a client computer 130 in communication with the host computer 100 over a network. Once logged into the user account, the user then attempts to access a computer source, such as file1.productxextension at access operation 504.

The host system 100 scans the Registry 116 and determines that the registry contains an association of this resource to PermissionProviderX.dll at registry operation 506. Upon the host system 100 finding the association in the Registry 116, the host system then loads the associated permission provider, PermissionProviderX.dll in this example, from storage at load operation 508. The host system 100 then calls a user permission method of that permission provider at call operation 510. As a result, the user permission method then looks up the permission table in the Registry 116 or other system configuration location to attempt to find the current user account for the current resource at look-up operation 512.

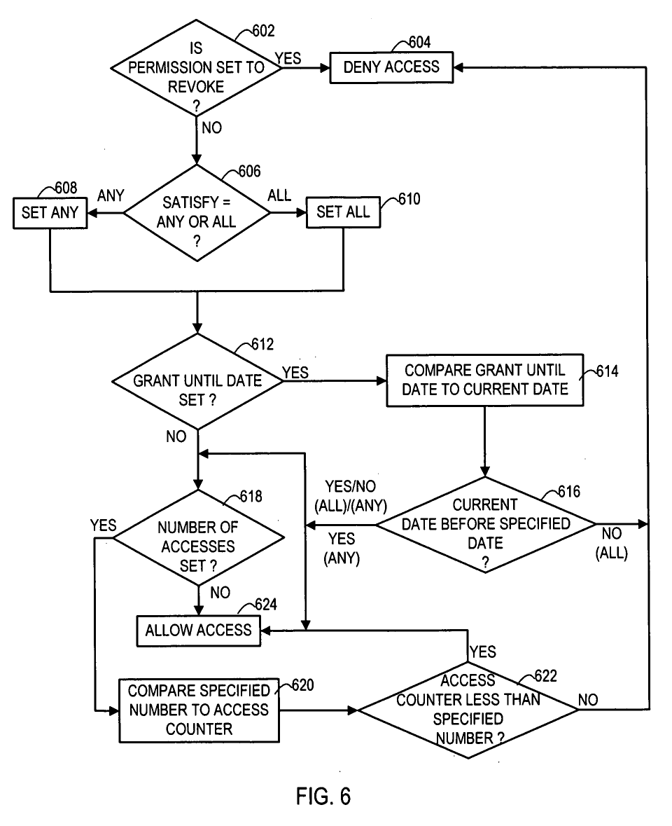

Once the entry in the permissions table is found, the user permission method then analyzes the conditional permissions to determine the grant/revoke status for this user account and resource at analysis operation 514. Here, the user permission method checks for the condition type, each condition name, and compares the value for each specified condition name to a data value obtained from the appropriate data source. Details of this analysis are discussed below in relation to FIG. 6. The user permission method outputs a true/false result based on the analysis, and the host system either grants or denies the user account access to the resource based on the true/false result at access operation 516.

FIG. 6 shows an example of detailed logical operations performed by the user permission method when analyzing the conditional permissions. The operations begin by query operation 602 detecting whether the permission for the user account and current resource is set to revoke in the permissions table. If so, then the user permission method outputs false and the host system denies access at denial operation 604. If permission is not set to revoke, then query operation detects whether the condition satisfy element is set to “any” or “all.” If set to “any,” then the user permission method sets a flag as “any” at set operation 608 and if set to “all,” then the user permission method sets a flag as “all” at set operation 610.

The user permission method next detects whether the grant until date has been set at query operation 612. If so, then the date specified in the expiry date condition name is compared to the current data that is accessed from the system calendar at comparison operation 614. Query operation 616 then determines whether the current date is before the specified expiry date. If not and the flag is set to all, then it is already determined that access should be denied so a false output is generated. The host system 100 then denies access at denial operation 604. If the current date is not before the specified expiry date and the flag is set to any, then it is not yet known whether to output true or false so operational flow proceeds to query operation 618 to check additional conditions.

If query operation 616 detects that the current date is before the specified expiry date and the flag is set to all, then it is not yet know whether to output true or false so operational flow proceeds to query operation 618 to check additional conditions. If query operation 616 detects that the current date is before the specified expiry date and the flag is set to any, then it is already known that the output should be true so the host system 100 grants the user account access to the resource at allowance operation 624.

When operational flow reaches query operation 618, it is detected whether the number of accesses has been set. If it has not been set, then since this is the last condition to check, it is known that the output should be true so the host system 100 grants the user account access to the resource at allowance operation 624. If the number of accesses has been set, then the specified number of accesses is compared to the number of accesses made thus far by the user account of the current resource which may be accessed from a one of various locations such as from a transactional log, from a counter that stores the number of access to a property of the resource, and the like.

If the number of accesses by the user account is less than the specified number in the permissions table, then it is known that the output should be true so the host system 100 grants the user account access to the resource at allowance operation 624. If the number of accesses by the user account is not less than the specified number in the permissions table, then it is known that the output should be false so the host system 100 denies the user account access to the resource at denial operation 604.

Thus, once the administrator has assigned permissions, or if default permissions are provided, then the user account may access the resource until the conditions as specified are no longer satisfied. The host system thereby manages access to resources without the administrator having to manually revoke access upon noticing that a particular user account should no longer have access, although the administrator may be given the ability to revoke at any time and at his discretion.

While the invention has been particularly shown and described with reference to various embodiments thereof, it will be understood by those skilled in the art that various other changes in the form and details may be made therein without departing from the spirit and scope of the invention. For example, the particular order of the operational flow for determining which user interface option the administrator has chosen may vary, and the options themselves may vary. As another example the particular order of the operational flow for determining whether the conditions are met may vary, and the conditions themselves may also vary.

What is claimed is:

1. A method of controlling access to computer resources, comprising:
storing at least one condition for a first user account and a first computer resource;
receiving a request to log-in to the first user account by a first user;
after the first user is logged-in to the first user account, receiving a request by the first user to access the first computer resource;
upon the first user attempting to access the first computer resource, determining whether the at least one stored condition for the first user account is satisfied;
when the at least one stored condition of the first user account is satisfied, granting the first user account access to the first resource; and
when the at least one stored condition is not satisfied, denying the first user account access to the first resource.

2. The method of claim 1, wherein storing the at least one condition comprises storing a plurality of conditions for the first user account and the first computer resource.

3. The method of claim 2, wherein storing the at least one condition comprises storing a condition that requires all other stored conditions for the first user account and the first computer resource to be satisfied before access is granted.

4. The method of claim 2, wherein storing the at least one condition comprises storing a condition that requires only one of the other stored conditions for the first user account and the first computer resource to be satisfied before access is granted.

5. The method of claim 1, wherein storing the at least one condition comprises storing a condition to determine whether a maximum number of granted accesses to the first computer resource for the first user account has been reached.

6. The method of claim 1, wherein storing the at least one condition comprises storing a condition to determine whether a date has been reached.

7. The method of claim 1, further comprising:
storing at least one condition for a first user account and a second computer resource, the at least one condition being different than the at least one condition of the first computer resource;
after the first user is logged-in to the first user account, receiving a request by the first user to access the second computer resource;
upon the first user attempting to access the second computer resource, determining whether the at least one stored condition for the first user account and second computer resource is satisfied;
when the at least one stored condition of the first user account and second computer resource is satisfied, granting the first user account access to the second resource; and
when the at least one stored condition of the first user account and second computer resource is not satisfied, denying the first user account access to the first resource.

8. The method of claim 1, wherein storing the at least one condition comprises storing the condition in a permissions table of a registry of a computer that grants and denies access to computer resources for the first account.

9. A computer readable medium containing instructions encoded thereon for performing acts comprising:
displaying a user interface including fields for receiving an identification of a first user account, a first computer resource, and at least one condition;
receiving the first user account, first computer resource, and at least one condition via the fields;
after receiving the first user account, the first computer resource, and the at least one condition and while a first user is logged-in to the first user account, receiving a request to by the first user account to access the first computer resource; and
determining whether the at least one condition is satisfied prior to granting the first user account access to the first computer resource.

10. The computer readable medium of claim 9, wherein the user account, the first computer resource, and the at least one condition are maintained in storage, and wherein displaying the user interface further comprises displaying a control to get existing permissions and upon selection of the control, accessing the user account, the first computer resource, and the at least one condition from storage and populating the fields of the user interface.

11. The computer readable medium of claim 9, wherein displaying the user interface comprises displaying an option to activate a revoke permission condition, and wherein determining whether the at least one condition is satisfied comprises determining whether the revoke permission condition is activated and if so then denying access.

12. The computer readable medium of claim 9, wherein displaying the user interface comprises displaying a field to set a grant until date condition, and wherein determining whether the at least one condition is satisfied comprises determining whether a current date is before a date specified by the grant until date condition.

13. The computer readable medium of claim 9, wherein displaying the user interface comprises displaying a field to set a maximum number of accesses, and wherein determining whether the at least one condition is satisfied comprises determining whether a number of accesses that have already occurred are less than the specified maximum number of accesses.

14. The computer readable medium of claim 9, wherein the resource comprises an individual file.

15. A computer system comprising:
a user input device;
a display screen; and
a processor, wherein the processor implements instructions to produce a user interface display on the display screen, the user interface providing fields for specifying a user account, a computer resource, and at least one condition,
wherein the processor further implements instructions to receive user input via the user input device to specify the user account, computer resource, and the at least one condition, and
wherein the processor further implements instructions to accept a log-in to the user account, receive a request from the use account to access the resource, and determine whether the at least one condition is satisfied prior to granting access to the resource for the user account.

16. The computer system of claim 15, further comprising a storage device and wherein the processor stores an association of the user account, the resource, and the at least one condition in the storage device.

17. The computer system of claim 16, wherein the association is stored as a table in a system registry.

18. The computer system of claim 15, wherein the at least one condition comprises a determination of whether a current date is before a specified date.

19. The computer system of claim 15, wherein the at least one condition comprises a determination of whether a number of accesses that have already occurred are less than a specified maximum number of accesses.

20. The computer system of claim 15, wherein the processor produces the user interface upon a request to set permissions for the resource by a different user account than the user account being associated with the resource and the condition.
